(19) United States
(12) Patent Application Publication
(10) Pub. No.: US 2011/0161108 A1
(43) Pub. Date: Jun. 30, 2011

(54) SYSTEMS AND METHODS FOR DETECTING DIVERSION IN DRUG DISPENSING

(75) Inventors: George Brad MILLER, Pittsburgh, PA (US); William Kaper, Slippery Rock, PA (US); John Brewster, McKees Rocks, PA (US)

(73) Assignee: McKesson Automation Inc.

(21) Appl. No.: 12/650,105

(22) Filed: Dec. 30, 2009

(51) Int. Cl. G06Q 50/00; G06Q 10/00

(52) U.S. Cl. 705/3; 705/318

(57) ABSTRACT

Systems and methods for detecting diversion in drug dispensing transactions are provided. The systems and methods described provide an integrated platform for collecting and analyzing data that describes a user's drug dispensing transactions and determines a diversion score for the user that indicates the relative severity of the user's diversion activities. The diversion score may be weighted to reflect the relative importance of a respective category of diversion activity to the identification of drug diverters with respect to other categories. Furthermore, in determining a user's diversion score, the user's transaction data may be compared with transaction data regarding the user's peers. In this way, for example, high diversion scores may indicate a high occurrence of suspicious activity, and users having high diversion scores may be further monitored and investigated to determine whether the particular user is indeed diverting drugs for illegitimate use.

### BACKGROUND

Drug use is a growing problem in today's world. Very often, drugs that are useful as medication under legitimate circumstances, such as pain-killers, are used illegally by individuals who have no medical reason to take the drugs. The addictive nature of the drugs augments the problem, as many people who start out taking a drug such as Oxycodone for legitimate medical reasons become addicted and continue to use the drug even after they no longer have a medical basis for taking the drug.

Healthcare providers, such as nurses and pharmacy technicians, are required to handle drugs as part of their daily routine, for example by dispensing drugs to patients. Unfortunately, the accessibility of the drugs to ill-intentioned individuals leads them to steal drugs for their personal use or sale. The desperation and ingenuity of such individuals, who may themselves be addicts, makes identifying the theft of drugs from healthcare institutions increasingly difficult to identify, and increasingly important.

### BRIEF SUMMARY OF THE INVENTION

Systems and methods are therefore provided for detecting the diversion of drugs during seemingly routine drug dispensing transactions. Data is received from a number of drug dispensing stations regarding drug dispensing transactions conducted by users of the stations. Based on this data, a diversion score is determined for each user that indicates a relative severity of diversion activity with respect to other users, thereby allowing auditors to conduct further investigations of individual users with certain diversion scores.

In one exemplary embodiment, a method for detecting diversion in drug dispensing transactions is provided. Transaction data regarding at least one drug dispensing transaction for a plurality of users is received, and a raw score for at least one category of diversion activity is calculated using the data. A diversion score is then determined at least partially based on the raw score modified in a way that reflects a relative severity of the diversion activity

In some cases, receiving the transaction data includes communicating with and receiving the data from a plurality of drug dispensing stations. The diversion score may be determined by comparing the user's transaction data with the transaction data received for the user's peers to calculate a variance. Alternatively, the diversion score may be determined by modifying the raw score independently of the transaction data received for the user's peers. The diversion score may be determined by weighting the raw score to reflect the relative importance of the respective category to the identification of drug diverters with respect to other categories.

In some cases, a total diversion score representing a sum of the diversion scores for each category of diversion activity may be determined. Furthermore, a report may be generated providing the diversion score or the total diversion score for at least one of the plurality of users. In addition, an alert may be provided when a particular user achieves a predetermined diversion score.

A number of problem areas for a particular user may also be determined based on the user's diversion score, where the number of problem area reflects the number of categories of diversion activity across all drugs dispensed for which the user has a diversion score bearing a preset relationship to a predetermined value. In some instances, an alert may be provided when a particular user attains a predetermined number of problem areas.

In other embodiments, a method for detecting diversion in drug dispensing transactions is provided, where a list identifying a plurality of users is displayed, each user being a dispenser of drugs. A calculated diversion score for each user may be displayed, as well as the number of problem areas for each user based on the diversion score. The number of problem areas may reflect the number of categories of diversion activity across all drugs dispensed for which the user has a diversion score bearing a preset relationship to a predetermined value, and the diversion score may reflect a relative severity of diversion activity.

In some cases, the selection of a particular user from the displayed users may be provided for, and details regarding the diversion score and the problem areas for the selected user may be displayed. The details displayed may include at least one of the categories of diversion activities, the diversion score for each category of diversion activities, the number of problem areas for each category of diversion activities, and/or the user's diversion activity as compared to the user's peers. Furthermore, displaying the user, the diversion scores, and the problem areas may include presenting the user, the diversion scores, and the problem areas in at least one format selected from the group consisting of a graphical representation and a tabular representation. Displaying the diversion score may include calculating a raw score for at least one category of diversion activity using transaction data regarding at least one drug dispensing transaction received for a plurality of users and weighting the raw score to reflect the relative importance of the respective category to the identification of drug diverters with respect to other categories.

In still other embodiments, a computer program product for detecting diversion in drug dispensing transactions is provided. The computer program product includes at least one computer-readable storage medium having computer-readable program code portions stored therein. The computer-readable program code portions include first, second, and third executable portions. The first executable portion may be configured for receiving transaction data regarding at least one drug dispensing transaction for a plurality of users, and the second executable portion may be configured for calculating a raw score for at least one category of diversion activity using the transaction data. The third executable portion may be configured for determining a diversion score at least partially based on the raw score modified in a way that reflects a relative severity of the diversion activity.

In some cases, the second executable portion may be further configured for comparing the user's transaction data with transaction data received for the user's peers to calculate a variance. In other cases, the second executable portion may be further configured for modifying the raw score independently of the transaction data received for the user's peers. The third executable portion may be further configured for weighting the raw score to reflect the relative importance of the respective category to the identification of drug diverters with respect to other categories.

In some embodiments, the computer program product may include a fourth executable portion configured for generating a report providing the diversion score for at least one of the plurality of users and at least one of the at least one categories of diversion activity. Alternatively or in addition, the computer program product may include a fourth executable portion configured for determining a number of problem areas for a particular user based on the user's diversion score, wherein the number of problem areas reflects the number of categories of diversion activities across all drugs dispensed for which the user has a diversion score bearing a preset relationship to a predetermined value

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates a typical environment in accordance with one exemplary embodiment of the present invention;

FIG. 2A is a schematic representation of a drug dispensing station in accordance with one exemplary embodiment of the present invention;

FIG. 2B is a schematic representation of a central server in accordance with one exemplary embodiment of the present invention;

FIG. 3 shows an example of a report displaying analyzed transaction data according to an exemplary embodiment of the present invention;

FIG. 4 shows an example of a report displaying a list of users, the calculated diversion score, and the number of problem areas according to an exemplary embodiment of the present invention;

FIG. 5 shows an example of a Modify window according to an exemplary embodiment of the present invention;

FIG. 6 shows an example of a detailed report according to an exemplary embodiment of the present invention;

FIG. 7 shows an example of a detailed report according to another exemplary embodiment of the present invention;

FIG. 8 depicts an example of a bar graph showing the diversion score for each user according to an exemplary embodiment of the present invention;

FIG. 9 depicts an example of a bar graph showing the diversion score for each category of diversion activity for a particular user according to an exemplary embodiment of the present invention; and

FIG. 10 is a flow chart illustrating a method of detecting diversion in drug dispensing transactions according to an exemplary embodiment of the present invention.

### DETAILED DESCRIPTION

Embodiments of the present inventions now will be described more fully hereinafter with reference to the accompanying drawings, in which some, but not all embodiments of the inventions are shown. Indeed, embodiments of these inventions may be embodied in many different forms and should not be construed as limited to the embodiments set forth herein; rather, these embodiments are provided so that this disclosure will satisfy applicable legal requirements. Like reference numerals refer to like elements throughout.

The systems and methods of the present invention may be used by healthcare facilities, such as hospitals, physicians' offices, pharmacies, and any other facility that dispenses drugs to patients, to facilitate monitoring and detection of the diversion of drugs. The systems and methods described provide an integrated platform for collecting and analyzing data that describes the users' drug dispensing transactions and determines a diversion score for the user that indicates the relative severity of the user's diversion activities. In this way, users with, for example, high diversion scores indicating a high occurrence of suspicious activity may be further monitored and investigated to determine whether the particular user is indeed diverting drugs for illegitimate use.

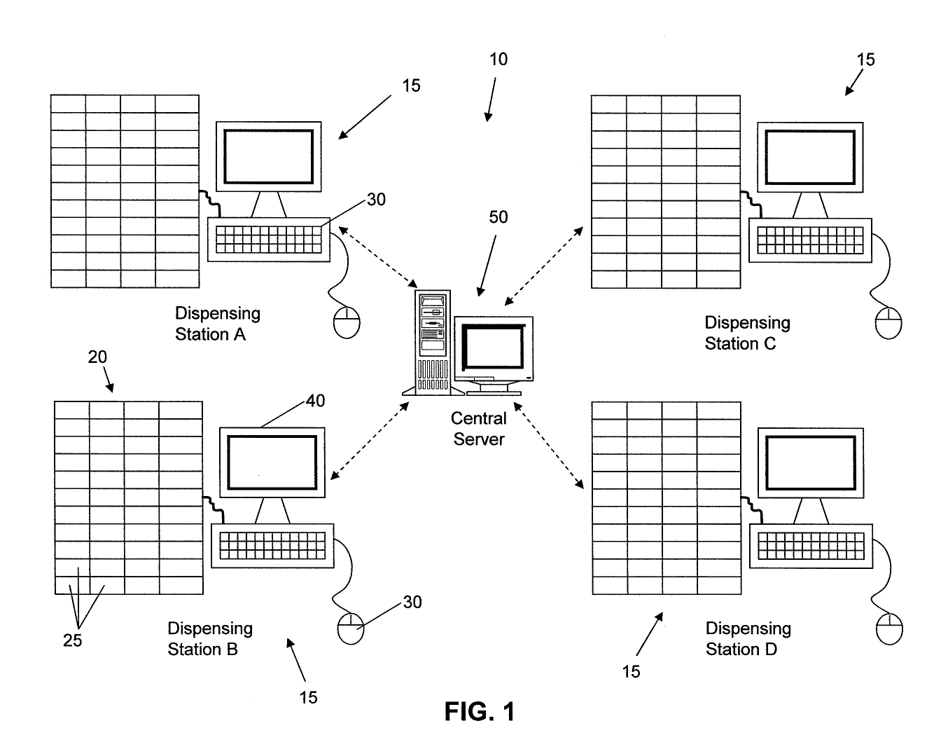

FIG. 1 illustrates an example of a typical environment in which the systems and methods of embodiments of the present invention may operate. For the purposes of explanation, the environment will be described in terms of a hospital setting, although it is understood that the systems and methods of embodiments of the present invention may be used in any setting where drugs are handled, supplied, and/or dispensed. Furthermore, the term “drug” will be used to describe a particular medication at a particular dosage that is dispensed in a particular form. Thus, one drug may be Oxycodone 5 mg tablet, whereas another drug may be Oxycodone 10 mg tablet. Using this example, Oxycodone 5 mg tablet and Oxycodone 10 mg tablet may be referred to as belonging to the same family because they have the same drug name (Oxycodone), although the dosage (in this case) is different.

A system 10 is shown in FIG. 1 that typically includes one or more dispensing stations 15, where pharmacists, pharmacy technicians, nurses, and other authorized personnel can access an inventory of drugs for dispensing to patients in a particular section, floor, or unit of the hospital. For example, in FIG. 1, four dispensing stations are shown: Dispensing Station A, Dispensing Station B, Dispensing Station C, and Dispensing Station D. Thus, depending on the size and type of healthcare facility, the facility may have any number of dispensing stations 15 as necessary to meet the needs of the particular facility. For example, the facility may have 1, 10, 50, or 100 dispensing stations.

Each dispensing station 15 may include a drug cabinet 20 with a number of drawers or “pockets” 25 for holding certain kinds and dosages of drugs. The pockets 25 may be locked in the closed position to secure the contents of each pocket until a user conducts a dispensing transaction to withdraw one or more drugs from the cabinet 20.

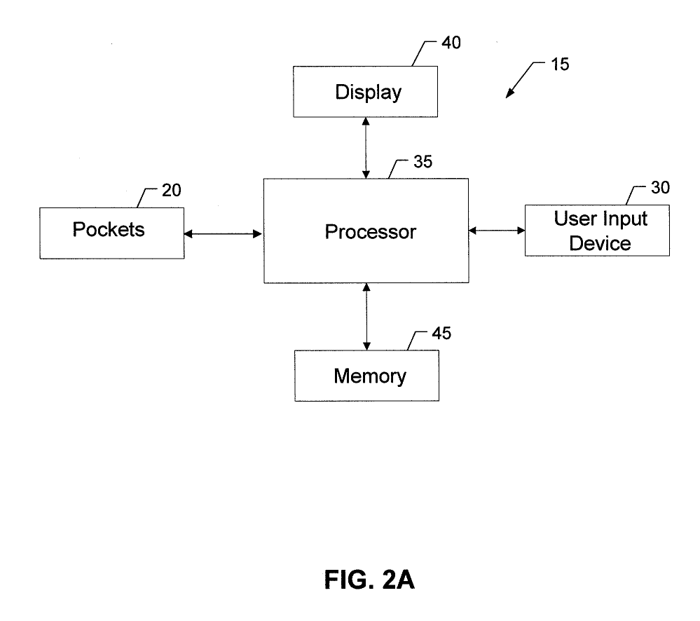

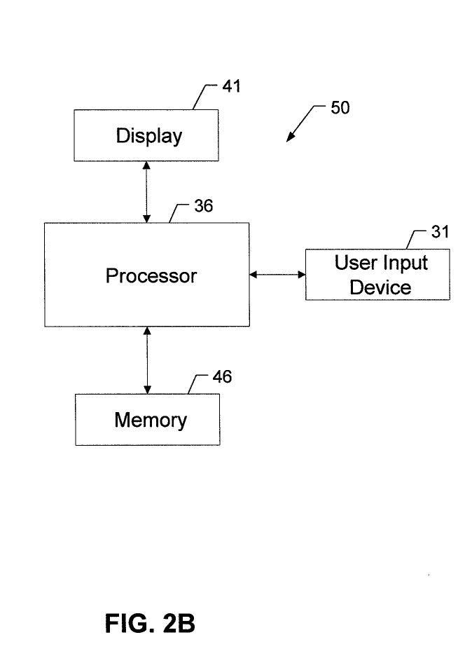

With reference to FIGS. 1 and 2A, the dispensing station 15 may also include a user input device 30, a processor 35, and a display 40. A user wishing to dispense a certain drug from the cabinet 20 may interface with the input device 30 to identify himself or herself as an authorized dispenser of drugs and request the necessary drug from the cabinet. The user input device 30 may include, for example, a keyboard, a mouse, a bar code reader, an RFID reader, or a combination of these devices that is configured to receive a User ID (such as the user's name or employee number). The input device 30 may also be configured to receive input from the user indicating the name of the drug requested, the dosage, the form (e.g., liquid or tablet), and/or the patient to whom the drug is to be administered.

The processor 35 may be configured to communicate with the input device 30 and the cabinet 20, such that upon receiving an authorized User ID, the processor 35 can cause the cabinet to unlock the pocket 25 corresponding to the requested drug for allowing the user to withdraw the drug from inventory. Once the pocket 25 is closed, the cabinet 20 may lock the pocket in the closed position to prevent any further removal of contents from the pocket.

The processor 35 may also be configured to communicate with the display 40 of the dispensing station 15 and may cause the display to present certain information to the user. For example, the display 40 may prompt the user to enter a password via the input device 30 upon receiving an authorized User ID as a second layer of security. The display 40 may also confirm the user's request for a particular drug by presenting the name of the requested drug, the requested dosage, and the requested form. If the user realizes that the wrong drug was requested, the user may have the opportunity to correct the request prior to the unlocking of the cabinet 20. The display 40 may also present information regarding the contents of one or more of the pockets 25, such as the type of drug contained in a particular pocket, the number of drugs remaining in the pocket, the time the pocket or cabinet was last accessed, etc.

The information received from the user during the drug dispensing transaction may be stored in a memory 45 of the dispensing station 15. Alternatively or in addition to local storage of such information, the transaction data may be communicated to a central server 50 and stored in a memory 46 thereof (shown in FIG. 2B). For example, transaction data may be uploaded from each delivery station 15 to the central server 50 each night or once a week, such as over a network connection, the Internet, or the Intranet.

With reference to FIG. 2B, the central server 50 may include an input device 31, a processor 36, and/or a display 41 for facilitating an auditor's interaction with the central server 50 for viewing and investigating analyzed transaction data, as will be discussed in greater detail below.

In addition to the user input received during the delivery transaction, other data may be collected by the dispensing stations 15 during the transaction. For example, the dispensing station 15 may be configured to monitor the duration of the transaction, the amount of time the pocket is left open, the number of pockets accessed during a single transaction, the time of day of the transaction, the location of the particular dispensing station (e.g., pediatric floor or psychiatric ward), etc., and this information may be included in the transaction data.

By analyzing the transaction data that is received from the various dispensing stations 15 regarding the drug dispensing transactions conducted by a number of users, suspicious trends in a particular user's activities may be identified that indicate the possibility that the user is diverting drugs for personal or illegal use. In particular, by comparing each user's transaction data with the transaction data of the user's peers, it may be possible to determine which users should be further investigated.

In this regard, a user's peers include the caregivers that should, theoretically, have the same or similar transaction data as the user. In other words, peers are those users who are expected to dispense similar drugs in the similar ways. For example, individuals who work on the same floor or the same unit of the hospital as the user may be classified as the user's peers. For example, caregivers working on the psychiatric floor, for example, may be peers to each other as they may be expected to dispense the same types of drugs in similar dosages and at the same frequency as others working on the same floor.

For example, although the dispensing of Haloperidol (a drug used to treat certain mental disorders such as schizophrenia) may be regarded as “suspicious” when compared to transaction data from users working in a pediatric ward, the same Haloperidol dispensing transaction may not raise any flags when compared to transaction data from users working on the psychiatric floor. As another example, caregivers working in the pediatric ward may generally be required to dispense a smaller dosage of a particular drug because the patients in the pediatric ward (infants and small children) may require less of the drug to achieve the same effect. Thus, if a child is prescribed 2 mg of a certain drug, but the drug comes in 5 mg units, the caregiver is typically required to dispense 5 mg of the drug and waste (e.g., throw away) 3 mg to achieve the prescribed 2 mg dosage. Therefore, although repeated wasting of a drug may be regarded as a diversion activity in, for example, the Emergency Room (e.g., possibly indicating that the “wasted” drug portion is being stolen for personal use), repeated wasting of drugs would not be outside the norm in the context of the pediatric ward peers.

A user may work on different floors or in different wards of the hospital on different days of the week, or a user may be reassigned from one ward to another. Thus, the peers of a user may be dynamically assigned, such that a user's peers on one day may not be the same as the user's peers on the following day. For example, the central server 50 or another device or processor in communication with the central server may determine a particular user's peers based on the transaction data received for a specified time period (e.g., the current day). In other words, the central server 50 may determine from the transaction data that a particular user was working in the maternity ward on a particular day and may thus assign all other caregivers working in the maternity ward that day as that user's peers. Accordingly, if transaction data is being analyzed over a period of one month, for example, the user's transaction data may be analyzed with respect to multiple groups of peers depending on who the user's peers were on a certain day in the window of analysis.

As mentioned above, there are many ways in which an ill-intentioned user may divert drugs for personal or illegal use. For example, a user may dispense drugs to a patient to whom the drug has not been prescribed. Thus, the user may input the patient's name to obtain access to the drug in the drug cabinet, but then, instead of administering the drug to that patient, the user may keep the drug for himself. As another example, a user may dispense a drug from the drug cabinet, and later access the cabinet to supposedly return the drug to inventory; however, instead of actually returning the drug, such as a syringe of Morphine, the user may replace the contents of the syringe with water to keep the morphine for illegal use. As yet another example, a user may access a drug dispensing cabinet on a floor other than the floor on which the user is working, for example at the end of the user's shift, to obtain drugs for personal use. Or, the user may conduct frequent inventories of a particular cabinet, stealing drugs during each inventory procedure. Thus, by analyzing certain aspects of the transaction data and comparing these aspects to corresponding transaction data for the user's peer group, it may be possible to identify suspicious behavior that could indicate drug diversion by one of the tactics described above, as well as several other tactics used by diverters.

In this regard, transaction data received regarding at least one drug dispensing transaction for a plurality of users may be used to calculate a raw score for at least one category of diversion activity. Considering the various ways users have been known to divert drugs for personal or illegal use, several categories of diversion activity may be considered, and a raw score may be calculated for each category, as summarized in Table 1:

TABLE 1

| Diversion Activity Category | Raw Score |
|---|---|
| User to Patient Max Dispenses | The total number of dispensing transactions by the user to a |
| | particular patient |
| Sole User Dispensing to Patients | The total number of patients to whom user dispensed, where |
| | no other user dispensed to that patient |
| Dispense Per Day Worked | The total number of dispensing transactions by the user on |
| Consistent Growth Over Time | Day N minus the total number of dispensing transactions by |
| | the user on Day 1 (where Day N is, for example, the 30^{th} or |
| | the 90^{th} day after Day 1) |
| Multi-Unit Dispensing in Single | The total number of days over a predefined period of time on |
| Day | which the user had dispensing transactions involving more |
| | than one dispensing station |
| Last To Access Pocket Prior to | The total number of times the user was the last to access a |
| Discrepancy | pocket of a drug dispensing cabinet prior to a discrepancy |
| | over a predefined period of time |
| Multiple Inventories Per Day | The total number of days on which the user conducted more |
| | than one inventory over a predefined period of time |
| Dispense Per Day Worked | The total number of dispensing transactions by the user over |
| | a predefined period of time divided by the number of days |
| | worked |
| High Patient Dispense | The total number of patients to whom the user dispensed |
| | over a predefined period of time |
| Total Dispense Qty | The total number of dispensing transactions by the user over |
| | a predefined period of time |
| Drug Family | The total number of dispensing transactions of a particular |
| | dosage within a drug family by a user. |
| High Override | The total number of dispensing transactions by the user over |
| | a predefined period of time for which the user conducted an |
| | override transaction |
| High Return | The total number of dispensing transactions by the user over |
| | a predefined period of time for which the user conducted a |
| | return transaction |
| High Waste | The total number of dispensing transactions by the user over |
| | a predefined period of time in which the user wasted |
| Qty Per Dispense | The total number of drugs dispensed by the user over a |
| | predefined period of time divided by the number of |
| | dispensing transactions |

The calculated raw score in one or more category may then be analyzed to determine whether a particular user warrants further investigation. In some embodiments, the raw score may be directly compared to the average raw score of the user's peers in that same category to determine a variance. The variance may thus indicate how much the user's transaction data for a particular category of diversion activity differs from the aggregate peer transaction data for the same category. In this case, the average peer raw score may be calculated by adding the total raw scores for a given category for all the peers and dividing by the number of peers, as follows:

$$Avg . Peer Raw Score = \frac{\sum Raw {Score}_{Peer}}{Total Number of Peers}$$

The variance represents the amount (e.g., percentage) by which the user's raw score is greater than or less than the corresponding average peer raw score for a particular category of diversion activity. For example, the variance may be calculated by the following equation:

$$Variance = ( \frac{User Raw Score}{Avg . Peer Raw Score} \times 100 ) - 100$$

As an example, if a user's raw score is 20 for a particular category of diversion activity, and the average peer raw score for the same category is 10, the variance would be calculated as ((20/10)*100)−100=100. Thus, the user in this case would be considered to have a variance of 100% in comparison to his peers because the user's raw score is twice as large as the average raw score of the user's peers.

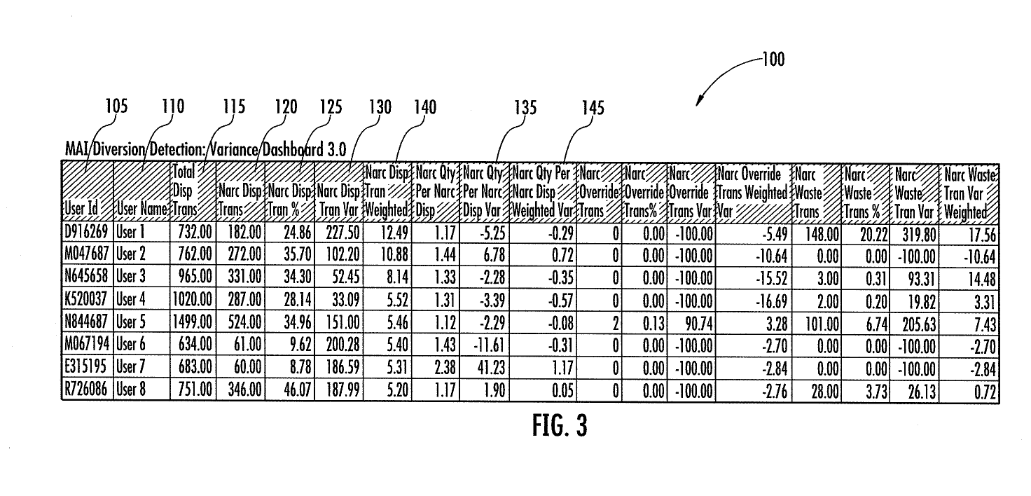

In other words, by analyzing the variance of a user's transaction data, an auditor, such as a charge nurse or a director of pharmacy, can determine whether the user's dispensing transactions fall within the normal range of activity that is expected of the user, or whether the user's activity may be indicative of a problem. For example, the auditor may generate a report using a computer in communication with the central server that presents the variance information for one or more users. An example of such a report 100 is shown in FIG. 3. The illustrated report, for example, provides each user's identification number 105, name 110, and the number of dispensing transactions conducted by the user 115. The total number of a particular type of dispensing transaction, such as the number of narcotics dispensing transactions 120, may also be presented. In this example, the percentage of narcotics dispensing transactions 125 compared to the total number of dispensing transactions may be provided. The raw scores for one or more category of diversion activity, as well as the variance, may be calculated and displayed for the auditor's review. For example, a narcotic dispensing transaction variance 130 and a narcotic quantity per narcotic dispensing variance 135 may be provided. Thus, an auditor reviewing the report 100 may decide that User 7 warrants further investigation due to the high variance in multiple categories, including, for example, a narcotic dispensing transaction variance 130 and a narcotic quantity per narcotic dispensing variance 135.

In some embodiments, the data may be processed to provide an indication of the relative importance of a respective category to the auditor's task of identifying diverters. Thus, if experience has shown that the quantity of narcotics dispensed per dispensing transaction 135 is easily influenced by the efficiency of a particular user and is thus not as reliable an indicator of diversion activity as, for example, the number of narcotic dispensing transactions 130, the latter category may weighted heavier than the first category to indicate to the auditor that the results of the latter are potentially more relevant.

For example, in FIG. 3, a narcotic dispensing transaction weighted variance 140 may be provided, as well as a narcotic quantity per narcotic dispensing weighted variance 145. As illustrated, the heavier weighting of the number of narcotic dispensing transactions 130 may confirm that User 7 should be investigated, because User 7's weighted value in this category of 5.31 is five times greater than the weighted value for the narcotic quantity per narcotic dispensing weighted variance 145 of 1.17.

To facilitate and simplify the identification of diversion activity, in some embodiments, a diversion score is determined for each user for each category of diversion activity considered. The diversion score reflects a relative severity of diversion activity with respect to other users. Thus, a high diversion score may indicate to an auditor that the particular user's behavior deviates greatly from the behavior of the user's peers, or that the user's behavior deviates from that of her peers in several categories of diversion activity.

Because each category of diversion activity may have relatively more or less value for identifying diverters, determining the diversion score may involve weighting the raw score to reflect the relative importance of the respective category to the identification of drug diverters with respect to other categories. In addition, determining the diversion score may involve comparing the user's transaction data for the particular category with the transaction data received from the user's peers.

For example, considering the category of User to Patient Max Dispenses described in Table 1 above, the user's raw score (e.g., the total number of dispensing transactions by the user to a particular patient) where the user dispensed more than any of the user's peers may be multiplied by ⅕ (representing a weight value) to obtain the diversion score. Thus, for example, considering the raw data in Table 2 below for a hypothetical user, the user may have dispensed more to Patient 4 and Patient 6 over the predefined time period (e.g., 1 week) than his highest dispensing peer for that patient. In this case, the diversion score for this category of diversion activity would be determined by dividing 2 (the number of patients to whom the user dispensed more than his peers) by 5 to get a diversion score of 0.4. Because the diversion score in this case is less than 1, the user would be assigned a diversion score of 0, indicating no suspicious behavior. Considering another example, if the columns were switched and the user had dispensed to 5 patients more than any of his peers, the diversion score would be calculated as 5/5=1.

TABLE 2

| | | Number of Dispensing |
|---|---|---|
| | Number of | Transactions to |
| | Dispensing | Patient by Highest |
| User's | Transactions to | Dispensing Peer for |
| Patients | Patient by User | that Patient |
| Patient 1 | 5 | 6 |
| Patient 2 | 8 | 10 |
| Patient 3 | 3 | 6 |
| Patient 4 | 13 | 10 |
| Patient 5 | 7 | 8 |
| Patient 6 | 10 | 6 |
| Patient 7 | 5 | 5 |

In the case of the category Sole User Dispensing to Patients, the diversion score may be determined by first multiplying the user's raw score from Table 1 above (e.g., the total number of patients to whom user dispensed, where no other user dispensed to that patient) by a weight value of 1/10. The weighted raw score is then added to a value indicative of the dispersion activity of the user's peers to obtain a diversion score. In particular, for example, first the percentage of the user's peers who have a similar pattern of dispensing may be calculated. For example, the percentage of the peers with a raw score within 5% of the user's raw score may be calculated. The result may be subtracted from 9, reflecting that when 10% or more of his peers have this dispensing pattern, the diversion score should be 0 (i.e., user's activity is not indicative of diversion). In terms of an equation, the calculation of the diversion score may be represented as follows:

$$( Raw Score \times Weight ) + ( \begin{matrix}\begin{matrix}Percentage over which diversion \\ score should be ignored - 1 -\end{matrix} \\ Peer Percentage with similar Raw Score\end{matrix} )$$

Thus, as a more specific example, if a user was the sole user to dispense to 30 patients, and only 1% of his peers dispensed to 30 or more patients, the diversion score would be calculated as follows:

$$( 30 \times 1 / 10 ) + ( 9 - 1 ) = 11$$

For the diversion category of Dispense Per Day Worked Consistent Growth Over Time, the average raw score calculated over, for example, a three-month period for a particular user's peers may be subtracted from the user's raw score and divided by 100, and the result may be rounded to the closest whole number. The result may then be increased by 1 to give the metric slightly more weight, as follows.

$$\frac{Raw Score}{100} + 1$$

The diversion score for Multi-Unit Dispensing in Single Day may be determined by simply dividing the raw score by 2. Thus, in this case, the weight value may be considered equal to 1.

$$\frac{Raw Score}{2}$$

Similarly, for the category Last to Access Pocket Prior to Discrepancy, the Raw Score may simply be equal to the diversion score (i.e., the score is multiplied by a weight value of 1). Thus, if over the predefined time period the user was last to access a particular pocket prior to a discrepancy on 5 days, then the diversion score would be equal to 5. A discrepancy may occur any time the actual amount in inventory does not match the reported amount by the dispensing station. For example, when the actual inventory for a particular pocket or dispensing station is less than the reported inventory, or when a pocket or dispensing station has excessive inventory, a discrepancy exists. Likewise, for the category Multiple Inventories Per Day, the user's raw score may be equal to the diversion score. The calculation of the diversion score in this case may reflect that users typically do not have discrepancies following their access of a drug cabinet, and thus no user should conduct multiple inventories on the drug cabinet.

Considering the category Dispense Per Day Worked, the diversion score may be determined by assigning 1 point for every 50% the user's variance is over the peer average raw score. This calculation is represented by the following equation:

$$\frac{( \frac{Raw Score}{Avg . Peer Raw Score} \times 100 ) - 100}{50}$$

The diversion score for the category High Patient Dispense may be calculated by dividing the user's variance for the number of patients to whom the user dispensed drugs. The result may be rounded to the nearest whole number to obtain the diversion score.

$$\frac{Raw Score - Avg . Peer Raw Score}{100}$$

For the category Total Dispense Qty, the diversion score may be increased by 1 point for every 100% that the user's variance is over the average peer raw score, as follows:

$$\frac{( \frac{Raw Score}{Avg . Peer Raw Score} \times 100 ) - 100}{100}$$

The diversion score for the category Drug Family may be calculated by inspecting a particular medication type. Each floor or unit of the hospital for which the user has a high variance may add 1 point to the diversion score. In addition, each different dosage size for which the user has a variance may also add 1 point to the diversion score. The total may then be divided by 2 to yield the diversion score, as follows:

$$\frac{( \begin{matrix}Number of Variances ( Unit ) + \\ Number of Variances ( Dosage )\end{matrix} )}{2}$$

In other words, the diversion score for the Drug Family category may be helpful to detect diversion activity by users that attempt to “spread out” their drug diversion across several dosages of a drug and across multiple dispensing stations in an effort to be inconspicuous (e.g., small variations across multiple dosages and multiple dispensing stations that add up to a significant amount of drug diversion). For example, a particular user may have the following variances with respect to her peers:
Dispensing of Morphine 1 mg on Unit A
Dispensing of Morphine 2 mg on Unit A
Dispensing of Morphine 1 mg on Unit B

Based on this transaction data, the user has a variance with respect to 2 units of the hospital (A and B) and also with respect to 2 dosages of Morphine (1 mg and 2 mg). Thus, the diversion score would be calculated as follows:

$$\frac{2 + 2}{4} = 1$$

The diversion score for the category High Override may be determined by dividing the user's raw score by the average peer raw score. Thus, a user with 50 overrides over a period of one month, for example, whose peers had an average of 10 overrides would have a diversion score of 50/10=5. In this context, an override or override transaction occurs when the user manually changes drug, dosage, or drug form information that is on a particular patient's list of drugs to be administered. For example, a nurse may need to do an override if her patient begins to have a heart attack so that she can access the appropriate drug to possibly stop the heart attack, even though the drug was not on the patient's normal list of prescribed medication.

For the category of High Return, the diversion score may be calculated by dividing the user's raw score by the average peer raw score and dividing the result by 2, as follows:

$$\frac{Raw Score / Avg . Peer Raw Score}{2}$$

For example, a user with 50 return transactions working with peers who have an average of 10 return transactions would have a diversion score of (50/10)/2=2.5, which rounds up to a diversion score of 3. The weighting of ½ for calculating the diversion score in this category, for example, reflects that this category may not be a strong indication of diversion activity.

The diversion score for High Waste may be determined by dividing the user's raw score by the average peer raw score, as follows:

$$\frac{Raw Score}{Avg . Peer Raw Score}$$

Thus, a user with 50 waste transactions whose peers have an average of 10 waste transactions would have a diversion score of 50/10=5.

Finally, the diversion score for the category Qty Per Dispense may be calculated by increasing the diversion score by 1 point for every 50% that the user's variance is over the average. This may be represented by the following equation:

$$\frac{( \frac{Raw Score}{Avg . Peer Raw Score} \times 100 ) - 100}{50}$$

In some embodiments, the diversion score for each category of diversion activity may be added together to come up with a total diversion score that represents the total severity of diversion activity for the user with respect to other users. In addition to providing an auditor with a total diversion score as a high level view of the user's activity, the number of problem areas may also be determined based on the user's diversion score in each category of diversion activity for each drug. In this regard, each problem area represents a specific type of transaction for which the user has a diversion score that bears a preset relationship to (e.g., is higher than) a predetermined value. In other words, each problem area indicates a single area of suspicious activity for a particular user.

For example, if the predetermined value is set to 0, the number of problem areas identified will be equal to the number of categories of diversion activity for each drug dispensed for which a user has a diversion score of 1 or more. Thus, by analyzing the number of problem areas determined for particular user, the auditor can determine whether the total diversion score reflects a single type of transaction for which the user's transaction data differs greatly from that of her peers, or rather multiple types of transactions for which the user's transaction data may differ slightly from that of her peers. Thus, the auditor may choose to focus further investigatory efforts on those users with a high total diversion score, irrespective of the number of problem areas identified, or those users with a large number of problem areas, irrespective of the total diversion score. At the same time, the inventors have discovered that as a user accumulates more and more problem areas for a single drug, it is more likely that the variance with respect to his peers is indicative of the diversion of drugs for personal or illegal user, rather than a coincidence. In some cases, for example, a user may have 10 or more problem areas with a single drug type.

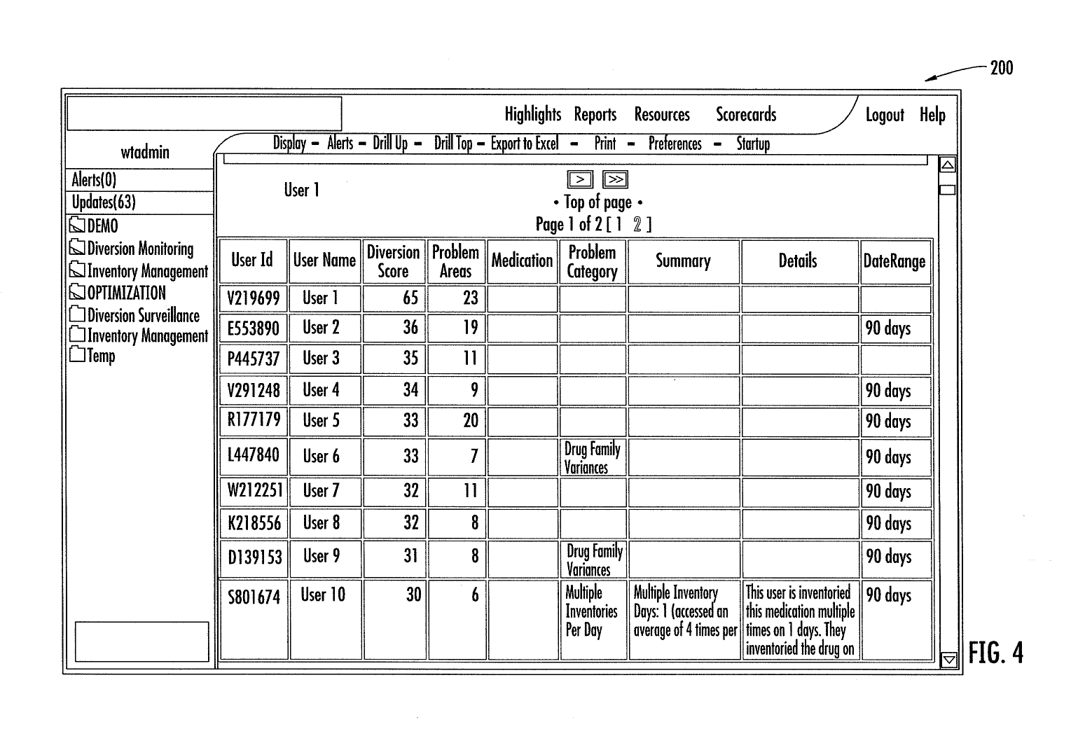

A list of the users for which transaction data is analyzed, a calculated diversion score (e.g., the total diversion score described above), and the number of problem areas for each user may be displayed to an auditor via an interactive computer application or user interface, such as by generating a report 200 as shown in FIG. 4. In this way, the auditor may be able to access details regarding each user, diversion score, or problem area and configure the presentation of the information to better evaluate and determine which users warrant further investigation for potential diversion activity. The auditor may, for example, access the application via the central server or via another terminal or computer in communication with the central server.

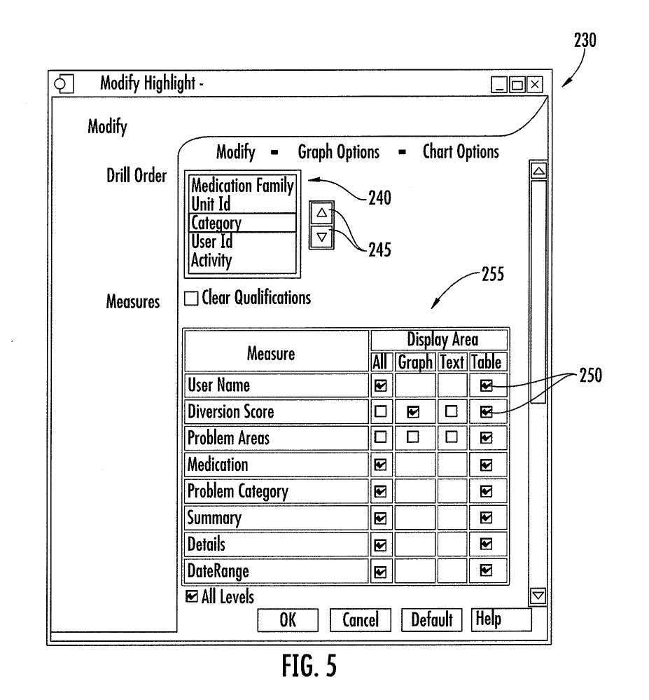

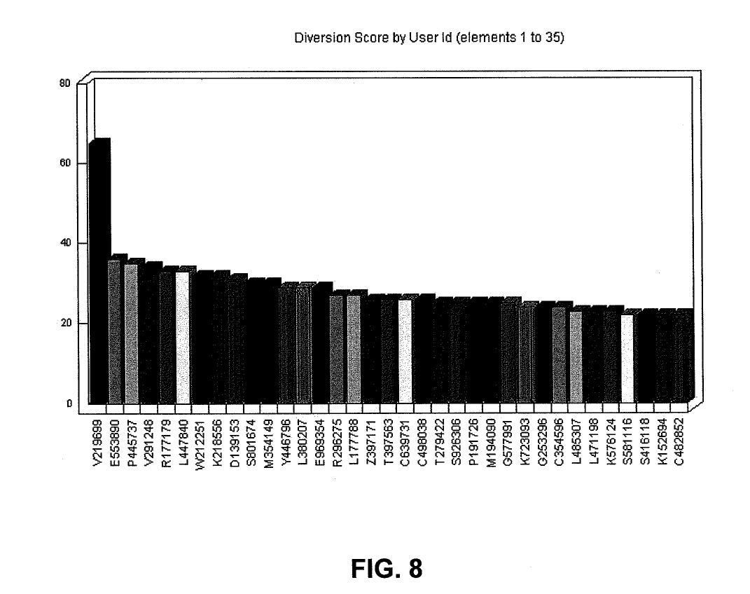

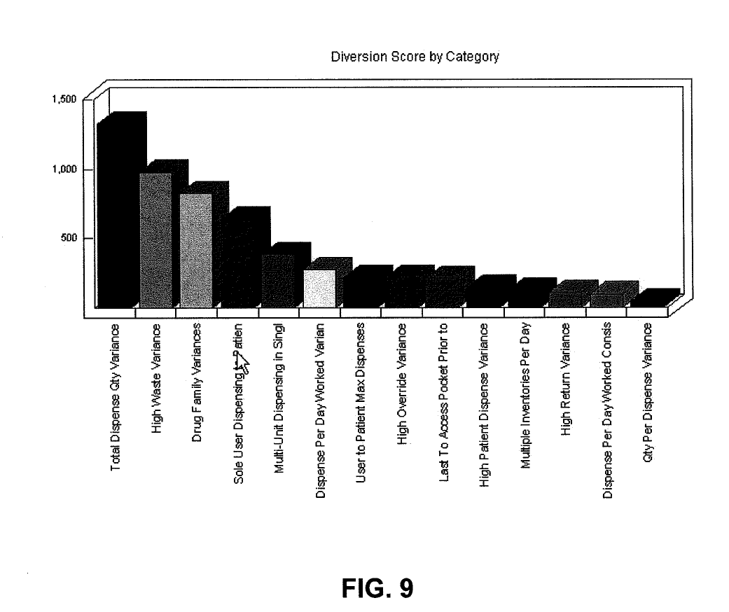

The auditor, for example, may be able to rearrange the information presented in the report 200 by selecting the fields to be presented in the report, the order of presentation, and/or the format of presentation. Turning to FIG. 5, for example, the auditor may access a Modify window 230 that allows the auditor to rearrange the order of fields presented in the report in a Drill Order section 240, for example, by selecting a field to move and using up and down buttons 245 to move the selected field up or down in order. In addition, the auditor may select checkboxes 250 in a Measures section 255 to indicate which measure (e.g., user name, diversion score, problem area, etc.) the auditor wishes to display and in which format. In this regard, the information may be displayed as a graphical representation (e.g., line graph or bar graph, as shown in FIGS. 8 and 9), or the information may be displayed as a tabular representation (e.g., as shown in FIG. 5).

The auditor may also be able to indicate which field to use for sorting the information. For example, in FIG. 4, the information for each user is sorted from highest diversion score to lowest diversion score. The auditor may sort the information by clicking on the heading for the field by which the information should be sorted (e.g., in FIG. 4).

Referring again to FIG. 4, in some embodiments, the application may provide for the selection of a particular user from the displayed users and may further display details regarding the diversion score and the problem areas for the selected user. For example, the auditor may be able to select, such as by using a mouse, a particular User ID corresponding to a user for which the auditor wishes to see more information. Looking at FIG. 4, for example, the auditor may wish to view details regarding User 1, as User 1 has the highest diversion score of all the listed users.

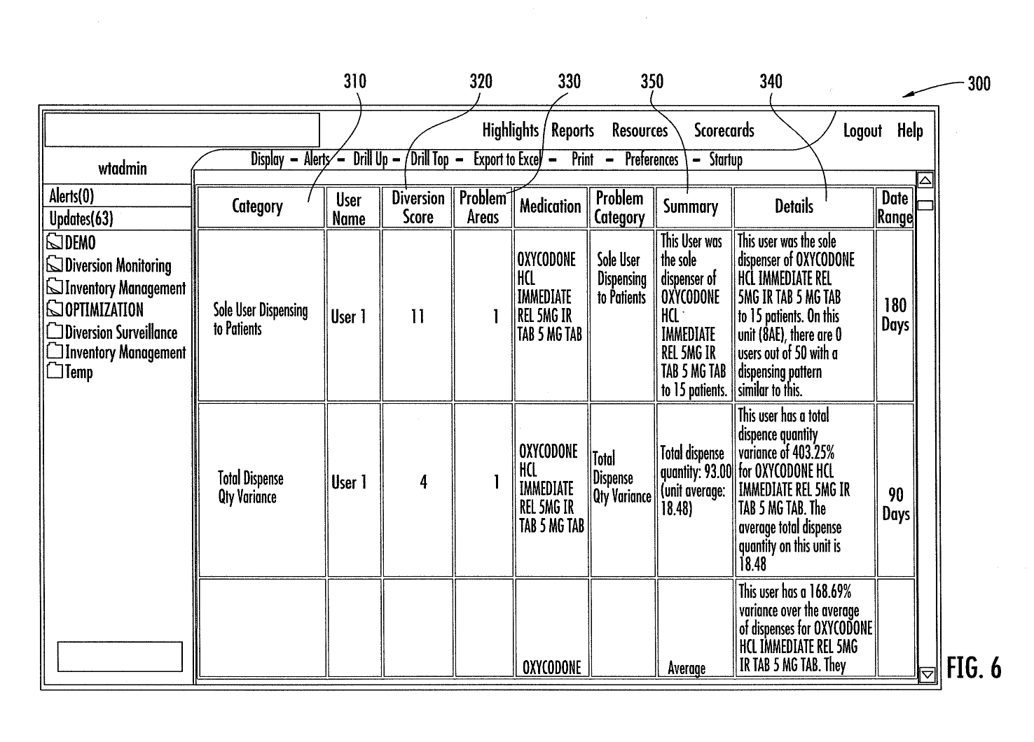

By clicking on the User ID for User 1, the auditor may be taken to the detailed report 300 shown in FIG. 6, which provides each category of diversion activity for the selected user 310, the diversion score for each category of diversion activity 320, the number of problem areas for each category of diversion activity 330, and the user's diversion activity as compared to the user's peers 340. Although in FIG. 6 User 1 had only a single problem area for each category shown, there may be multiple problem areas for each category of diversion activity 330 as the user may have had suspicious activity with respect to multiple drugs within each category of diversion activity. For example, the user may have been the sole user dispensing to patients for Morphine 1 mg as well as for Morphine 2 mg.

Details regarding the user's diversion activity as compared to the user's peers 340 may be provided as a narrative description of the Details column explaining why a particular category received a particular diversion score. In the case of the category Sole User Dispensing to Patients shown in FIG. 6, the Details 340 may read “The user was the sole dispenser of Oxycodone HCL IMMEDIATE REL TAB to 15 patients. On this unit (8AE), there are 0 users out of 50 with a dispensing pattern similar to this.” Thus, the Details 340 may provide an explanation to the auditor of why a particular category received a certain diversion score.

Furthermore, in some cases, a Summary 350 of the category of diversion activity may be provided to put the category title into context. In FIG. 6, for example, the Summary 350 provides that “The user was the sole dispenser of Oxycodone HCL IMMEDIATE REL TAB to 15 patients.”

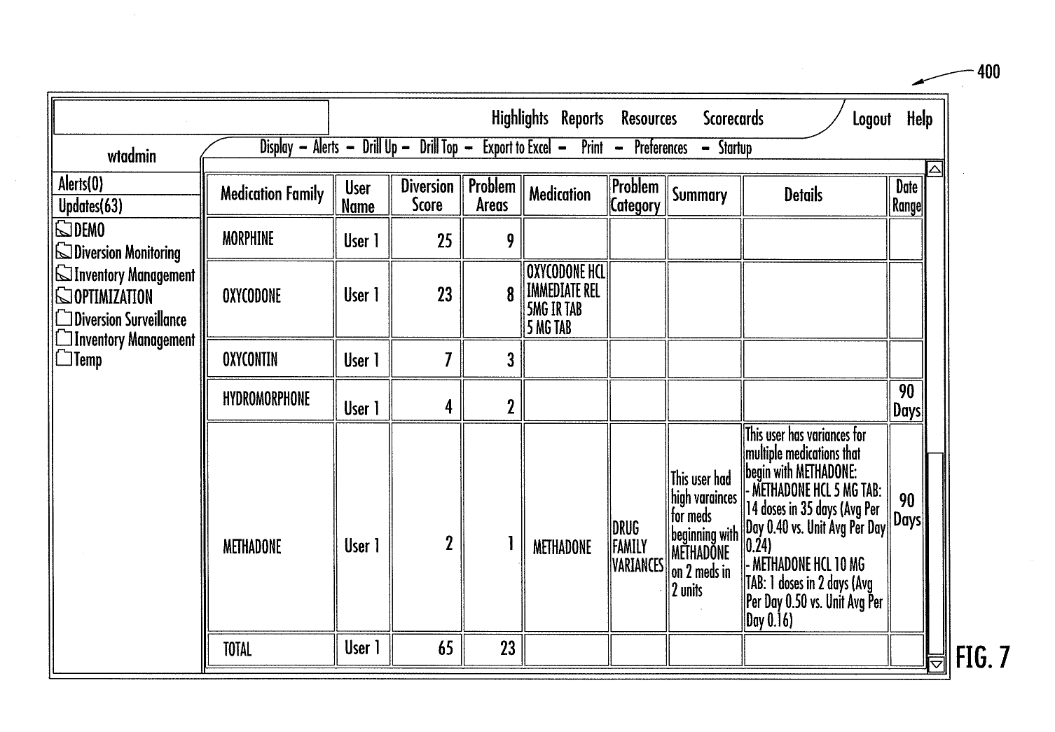

The auditor may be able to generate and display other reports by clicking on certain interactive fields in the currently displayed report. For example, from the report 300 shown in FIG. 6, the auditor may be able to click on a particular category of diversion activity, such as Sole User Dispensing to Patients, to generate a report showing all of the user's problem areas within the selected category. An auditor clicking on a category (not shown) identifying a high diversion score and a high number of problem areas may be taken to a report 400 as shown in FIG. 7, for example. The report 400 in FIG. 7 may display the name of each drug under the selected category for which the user had a diversion score higher than a predefined diversion score (such as 0). The report 400 may also provide the diversion score for each drug name, as well as the number of problem areas identified for each drug name.

As mentioned above, various aspects of the information for one or more user may be displayed for the auditor in multiple formats, such as in a graphical representation (e.g., a bar graph) or a tabular representation. In FIG. 8, for example, the various users for which transaction data was analyzed are provided on an X-axis of a bar graph, with the diversion score (e.g., the total diversion score across all categories of diversion activity analyzed) provided on the Y-axis to illustrate to the auditor, in a graphical format, the users having the highest diversion scores. Similarly, in FIG. 9, the categories of diversion activity for a particular (e.g., selected) user may be provided on the X-axis, with the diversion score for each category provided on the Y-axis. In this way, the auditor may be able to see at a glance the categories in which the user appeared to engage in suspicious activity, and the auditor may conduct further investigations of the user accordingly.

In some embodiments, the auditor may be able to configure the computer application to alert the auditor when a particular user or department achieves a predetermined diversion score. For example, if a particular user is already under investigation, the auditor may wish to know as soon as the user achieves a diversion score greater than 0 (for example) in any category. As soon as this occurs, the auditor may be notified by the system, such as by an automatically generated e-mail, voice mail, or text message, so that the auditor can interface with the system and retrieve the relevant details regarding the user's diversion activities.

Similarly, the auditor may also be able to configure the system to provide an alert when a particular user or department attains a predetermined number of problem areas. For example, the auditor may wish to know when the system has identified 2 or more problem areas for a particular user (or any user), such that the auditor may be able to immediately access the system and retrieve details regarding the user and the problem areas for further investigation. Again, the auditor may be notified by the system in several ways, including by an automatically generated e-mail, voice mail, or text message.

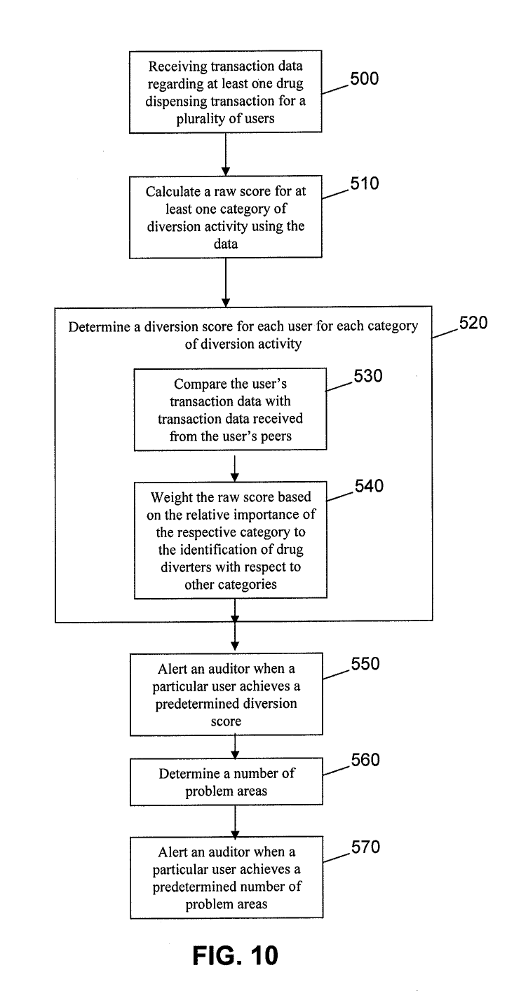

Turning now to FIG. 10, a flow diagram is provided illustrating a method for detecting the diversion of drugs according to the embodiments described above. Initially, transaction data is received regarding at least one drug dispensing transaction for a plurality of users. Block 500. A raw score is then calculated for at least one category of diversion activity using the transaction data. Block 510. A diversion score for each user for each category of diversion activity is then determined. Block 520. In determining the diversion score, the user's transaction data may be compared with transaction data received from the user's peers. Block 530. In addition or alternatively, the raw score may be weighted based on the relative importance of the respective category to the identification of drug diverters with respect to other categories. Block 540.

In some cases, an alert may be provided when a particular user achieves a predetermined diversion score. Block 550. In addition, a number of problem areas may be determined, and an alert may be provided when a particular user achieves a predetermined number of problem areas. Blocks 560, 570.

Exemplary embodiments of the present invention have been described above with reference to block diagrams and flowchart illustrations of methods, apparatuses (i.e., systems) and computer program products. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus, such as the processor 36, to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. For example, numerous other categories of diversion activity may be defined, and the various weights used to determine a diversion score for each category may be adjusted and configured (for example by the auditor) to reflect the relative importance of the category to the identification of drug diverters with respect to the other categories used by the auditor or healthcare facility in view of the healthcare facility's particular experience with drug diverters and/or other factors unique to that particular healthcare facility. Similarly, the algorithms provided above for calculating the raw scores and diversion scores may be adjusted and configured by the auditor or other representative of the healthcare facility to suit the particular facility's needs.

In the same way, the presentation of the analyzed transaction data (e.g., the reports and graphs referenced above and illustrated in the figures) may be adjusted and configured by the auditor, for example, to provide a view and/or level of detail that best suits the auditor's needs. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method of detecting diversion in drug dispensing transactions comprising:
receiving transaction data regarding at least one drug dispensing transaction for a plurality of users;
calculating a raw score for at least one category of diversion activity using the data; and
determining a diversion score at least partially based on the raw score modified in a way that reflects a relative severity of the diversion activity.

2. The method of claim 1, receiving transaction data comprises communicating with and receiving the data from a plurality of drug dispensing stations.

3. The method of claim 1, wherein determining the diversion score comprises comparing the user's transaction data with the transaction data received for the user's peers to calculate a variance.

4. The method of claim 1, wherein determining the diversion score comprises modifying the raw score independently of the transaction data received for the user's peers.

5. The method of claim 1, wherein determining the diversion score comprises weighting the raw score to reflect the relative importance of the respective category to the identification of drug diverters with respect to other categories.

6. The method of claim 5 further comprising determining a total diversion score representing a sum of the diversion scores for each category of diversion activity.

7. The method of claim 6 further comprising generating a report providing the diversion score or the total diversion score for at least one of the plurality of users.

8. The method of claim 1 further comprising providing an alert when a particular user achieves a predetermined diversion score.

9. The method of claim 1 further comprising determining a number of problem areas for a particular user based on the user's diversion score, wherein the number of problem area reflects the number of categories of diversion activity across all drugs dispensed for which the user has a diversion score bearing a preset relationship to a predetermined value.

10. The method of claim 9 further comprising providing an alert when a particular user attains a predetermined number of problem areas.

11. A method of detecting diversion in drug dispensing transactions comprising:
displaying a list identifying a plurality of users, wherein each user is a dispenser of drugs;
displaying a calculated diversion score for each user; and
displaying the number of problem areas for each user based on the diversion score, wherein the number of problem areas reflects the number of categories of diversion activity across all drugs dispensed for which the user has a diversion score bearing a preset relationship to a predetermined value,
wherein the diversion score reflects a relative severity of diversion activity.

12. The method of claim 11 further comprising providing for the selection of a particular user from the displayed users, and displaying details regarding the diversion score and the problem areas for the selected user.

13. The method of claim 12, wherein the details displayed include at least one of the categories of diversion activities, the diversion score for each category of diversion activities, the number of problem areas for each category of diversion activities, and the user's diversion activity as compared to the user's peers.

14. The method of claim 11, wherein displaying the user, the diversion scores, and the problem areas comprises presenting the user, the diversion scores, and the problem areas in at least one format selected from the group consisting of a graphical representation and a tabular representation.

15. The method of claim 11, wherein displaying the diversion score comprises calculating a raw score for at least one category of diversion activity using transaction data regarding at least one drug dispensing transaction received for a plurality of users and weighting the raw score to reflect the relative importance of the respective category to the identification of drug diverters with respect to other categories.

16. A computer program product comprising at least one computer-readable storage medium having computer-readable program code portions stored therein, the computer-readable program code portions comprising:
a first executable portion configured for receiving transaction data regarding at least one drug dispensing transaction for a plurality of users;
a second executable portion configured for calculating a raw score for at least one category of diversion activity using the transaction data; and
a third executable portion configured for determining a diversion score at least partially based on the raw score modified in a way that reflects a relative severity of the diversion activity.

17. The computer program product of claim 16, wherein the second executable portion is further configured for comparing the user's transaction data with transaction data received for the user's peers to calculate a variance.

18. The computer program product of claim 16, wherein the second executable portion is further configured for modifying the raw score independently of the transaction data received for the user's peers.

19. The computer program product of claim 16, wherein the third executable portion is further configured for weighting the raw score to reflect the relative importance of the respective category to the identification of drug diverters with respect to other categories.

20. The computer program product of claim 16 further comprising a fourth executable portion configured for generating a report providing the diversion score for at least one of the plurality of users and at least one of the at least one categories of diversion activity.

21. The computer program product of claim 16 further comprising a fourth executable portion configured for determining a number of problem areas for a particular user based on the user's diversion score, wherein the number of problem areas reflects the number of categories of diversion activities across all drugs dispensed for which the user has a diversion score bearing a preset relationship to a predetermined value.
